(19) United States
(12) Patent Application Publication
(10) Pub. No.: US 2010/0044206 A1
(43) Pub. Date: Feb. 25, 2010

(54) Pipeline System

(75) Inventor: Stephen Shelley, Victoria (AU)

Correspondence Address: SCHWEGMAN, LUNDBERG & WOESSNER, P.A., P.O. BOX 2938, MINNEAPOLIS, MN, 55402, US

(73) Assignee: Australia Creative Technologies PTY LTD, Knoxfield VIC (AU)

(21) Appl. No.: 12/085,372

(22) PCT Filed: Nov. 20, 2006
(86) PCT No.: PCT/AU2006/001748

§ 371 Date: Oct. 20, 2009

(30) Foreign Application Priority Data
Nov. 22, 2005 (AU) 2005906494
Jun. 27, 2006 (AU) 2006903448

(51) Int. Cl. B01D 1/22; F15D 1/00

(52) U.S. Cl. 203/11; 137/560; 202/237; 202/234; 202/262

(57) ABSTRACT

A desalination pipeline system (10) including a first pipeline (12) extending from a salt water source (14) for transferring salt water therethrough. The system includes at least one saltwater desalinator (18) in fluid connection with the first pipeline (12), enabling salt water to be drawn from the first pipeline (12) to the at least one desalinator (18). Each of the salt water desalinators (18) is provided to desalinate at least part of the water drawn from the first pipeline (12). Each desalinator (18) is in fluid connection with a second pipeline (24) extending between the salt water source (14) and the target outlet (16), such that the water that has been desalinated in a desalinator (18) is transferred to the second pipeline (24).

The present invention relates generally to a pipeline system for supplying fluid, such as water from a source to a target location. More particularly, the invention relates to a pipeline system for supplying fresh water to a target location from a salt-water source and will, hence, be generally described in this context. However, it is to be appreciated that the present invention may be utilized in other applications including, but not limited to, the removal of contaminants from water or other fluids.

The adequate supply of fresh water is an ever increasing problem in today's society, particularly in arid regions of the world, regions prone to drought and regions supporting large populations.

Various solutions have been proposed for addressing society's water shortage problem. Generally, however, such proposals are prohibitively expensive to set-up, prohibitively expensive to operate, unable to provide sufficient fresh water for society's needs, inefficiently use society's valuable power resources, undesirably add to greenhouse gas emissions, or introduce undesirable long-term human and environmental hazards.

One existing proposal for providing fresh water to inland communities such as, for example communities in rural Australia, is to provide a desalination plant on the Australian coast for the desalination of ocean water and then to transit the desalinated, fresh water by a pipeline to the rural community requiring fresh water. Currently available desalination plant technologies are expensive to set-up, expensive to operate and return unwanted and highly saline water back into the ocean. Further, in some circumstances it may also riot be feasible to remove fresh water for other uses at locations along the length of the pipeline in any significant volume, because this adversely affects the volume of fresh water reaching the rural community at the end of the pipeline.

It would be desirable to provide an alternative arrangement for supplying fresh water. It would also be desirable to provide an arrangement for supplying fresh water addressing at least some of the problems inherent in existing proposals.

Further, it would be desirable to provide an arrangement for decontaminating fluid.

According to a broad aspect of the present invention, there is provided a desalination pipeline system.

The pipeline system includes a first pipeline extending from a salt water source for transferring salt water therethrough, and at least one salt-water desalinator.

Each salt-water desalinator is in fluid connection with the first pipeline, enabling salt water to be drawn from the first pipeline to the at least one desalinator. The desalinator is provided to desalinate at least part of the water drawn from the first pipeline.

Each desalinator is in fluid connection with a second pipeline extending between the at least one salt water desalinator and a target outlet, such that the water that has been desalinated in the desalinator is transferred to the second pipeline and therethrough to the target location.

Thus, the second pipeline is provided to provide desalinated water at the target outlet.

The pipeline system may include a third pipeline that is acting as the salt water source for the first pipeline, the third pipeline being in fluid connection with the first pipeline. The third pipeline is provided for replenishing the first pipeline with salt water upon the desalinator converting salt water removed from the first pipeline into desalinated water. This third pipeline may, for example, be part of a grid connecting ocean based salt water sources to a pipeline system(s) in order to provide a network of fresh water throughout a country or region.

It is envisaged that the water that has been desalinated will be fresh water.

The salt water in the first pipeline that has not been desalinated in one desalinator will continue through the first pipeline towards a further or final desalinator in the pipeline.

The target outlet may be any one or more of a dam, reservoir, catchment or other fresh water reserve, while the salt water source may be the third pipeline or the ocean.

It is to be appreciated that the salt water source could also be, for example, a salt damaged river or waterway. In this respect, the present invention may be used to desirably reduce the salt level in such rivers or waterways by taking water in from such a waterway, cleaning it and then returning it to the waterway.

It is to be appreciated that the source could be a river or waterway with some other contamination besides salt. The present invention may be used to remove contaminants from such a waterway by taking water in from such a waterway, cleaning it and then returning it to the waterway.

It is to be appreciated that the source could be the settling ponds, or other similar source, of a factory where contaminated water is produced as a by-product of the operation of the factory. The present invention may be used to remove contaminants from such a waterway by taking water in from such a waterway, cleaning it and then outputting the clean water into separate clean water storage catchments. The cleaned water may be appropriate for re-use in the factory or of such quality it can be returned to the natural waterways.

The system may include two or more desalinators located at desired and/or convenient locations along the pipeline system. For example, a desalinator may be located at each populated region along a pipeline system so as to provide desalinated water for each of those regions.

The system may be modular in form, including a plurality of desalinators connected between pipeline system sections.

It is envisaged that multiple desalinators could be connected in series, in parallel, or in a network between a salt water source (or third pipeline section) and a target outlet.

Being modular, the system may be arranged in any desired layout. It is envisaged that, generally speaking, each of the desalinators would be located above ground and the pipeline system sections would be located either above or below ground.

Each desalinator may be combined with first, second and, optionally, third pipeline sections to create a desalinating module that may be connected within an overall system such as a grid or network to other desalinating modules and/or pipeline system sections. In a further arrangement two or more desalinators may be combined in the one desalinating module.

Each module may include connectors at one or both ends of each of the first, second and optional third pipeline section for enabling the module to be connected to other modules and/or pipeline system sections in any appropriate layout.

The present invention is also broadly directed to a desalinator for use in a desalination pipeline system. The desalinator includes a desalinating chamber. The desalination chamber includes a salt-water inlet, a water dispersal unit for dispersing water within the chamber, an evaporated water outlet for the removal of evaporated water from within the chamber, a salt-water outlet for removal of non-evaporated salt-water from within the chamber, a means for providing an air stream within the chamber.

Preferably, a condensation chamber is provided for extracting freshwater from the evaporated water.

The present invention is also broadly directed to a water dispersal means for dispersing water entering a desalinator. The dispersal means includes one of a shower, spray or other water dispersal device, through which water passes and is dispersed.

The water dispersed in the desalination may advantageously be suspended in the air stream in the chamber by any suitable arrangement. For example, the water may be suspended by spraying it onto evaporation pads.

Salt is generally removable from the chamber and pipeline system, or can be returned to the salt-water in the first pipeline, resulting in an increased concentration of salt within the first pipeline.

Any suitable desalination chamber shape may be selected. Different shaped desalination chambers may be appropriate for different applications. Examples of possible desalination chamber shapes are:
A cylindrical shape that is taller than it is wide
A pipeline shape that is wider than it is tall

The pressure in the desalinating chamber may optionally be lowered by any suitable means to further increase the efficiency of the evaporation.

An alternative gas mixture may be supplied to the desalination chamber in place of or in addition to natural air in order to introduce a gas that will be of some further benefit. For example a gas may be used to render harmless a chemical or biological agent that may be contained in the air or water in the desalination chamber.

The gas mix in the desalination chamber may optionally be changed from natural air in order to induce or retard the evaporation process. This may be used to reduce the temperature at which evaporation is taking place, or to restrict the evaporation process in order to prevent or retard the evaporation of some contaminants.

In one form, the desalinating chamber includes a salt catchment for collecting salt produced in the chamber. However, it is to be appreciated that the salt produced in the chamber could be fed back into the first pipeline for collection and possible processing at the target outlet or other suitable location in the pipeline system. The salt catchment may be provided in the chamber or may form a separate chamber.

It is to be appreciated that removal of salt from the chamber may be achieved by the removal of salt suspended in unevaporated salt water, and then returning salt water via a filtered pipe without the suspended salt.

Preferably, the salt-water fed from the first pipeline is heated prior to reaching each of the desalinators. Heating of the salt-water may occur by any suitable means and, in a preferred form, is heated by a solar water heater. Preferably, the salt-water is heated to a temperature of at least 55° C., with the efficiency of the system generally increasing the higher the temperature of the water being fed to each module.

It is to be appreciated that it is not necessary to heat the water to boiling point, whatever temperature that may be in the chosen gas mix of the desalination chamber, but it may be advantageous in a particular application.

It is to be appreciated that it is possible to enhance the cost effectiveness of the system by the use of low-grade heat available as a by-product of another operation. In this respect the present invention lends itself most usefully to cleaning water for re-use in factories.

Removal of non-evaporated salt water from within the chamber may be by any suitable means, including by a solar water heater acting as a thermosiphon on the salt-water collected in or towards the bottom of the chamber. Alternatively, a pump or screw may be used to remove the salt-water from or towards the bottom of the chamber and return it to the first pipeline.

Preferably, the desalination chamber includes an extraction fan, turbine or other air-flow generating means for assisting in extracting evaporated water through the evaporated water outlet. The extraction fan, turbine or other air-flow generating means may be powered by any suitable means, including by solar power and/or a wind power unit.

In a preferred form the desalination chamber is air-tight.

The desalination pipeline system may include means for pumping the salt-water in the first and third pipelines along the pipelines towards the target outlet. Likewise, the system may include means for pumping at least partially desalinated salt-water in the second pipeline towards the target outlet. It is to be appreciated that it may be appropriate to generate differing flow-rates in each of the first, second and third pipelines. Any suitable means for pumping may be provided, including solar power, and/or windmill generated power.

Each of the first, second and third pipelines may be insulated to potentially different extents along at least a portion of their respective lengths adjacent each desalinator to reduce heat energy losses to outside ambient temperatures. Any suitable insulation type may be adopted.

The desalination chamber may also be insulated to reduce heat energy losses to outside ambient temperatures. Any suitable insulation type may be adopted.

To reduce the net energy requirement of evaporation, and to increase the rate of condensation, the condensation chamber may include heat exchangers to return energy recovered through the condensation process to the evaporation process.

To increase the achievable humidity in the evaporation chamber the air stream may advantageously be pre-heated. The air stream may be preheated through the use of solar heaters and heat exchangers, the use of available low grade heat, or by any other means.

In another aspect, the present invention is broadly directed to a method of desalinating salt-water. The method includes feeding salt-water into a desalination chamber through a salt-water inlet, dispersing the water within the chamber, supplying an air stream within the chamber, removing the evaporated water from the chamber through an evaporated water outlet, and removing non-evaporated salt-water from within the chamber though a salt-water outlet.

The evaporated water may pass from within the chamber through the evaporated water outlet and into a condensation chamber.

The salt-water dispersal may adopt any suitable form including, but not limited to creating a water spray, shower, atomization or other water dispersal form within the chamber. Preferably, the stream of air within the chamber is directed across the path of the dispersed water to assist in the capture of evaporated water. The water may be suspended in the air stream by any means including evaporation pads. The air-stream may be preheated.

The method may also include removal of salt from within the chamber though a salt outlet. However, the salt may be: removed suspended in the non-evaporated salt-water through the salt-water outlet.

The method may include heating the salt-water prior to entering the desalination chamber, as this will desirably increase the overall efficiency of the desalination system.

The method may also include operating an extraction fan, turbine or other device within the chamber to enhance removal of evaporated water from within the chamber.

Preferably, the salt-water outlet is in fluid communication with the first pipeline.

Salt water removed from the desalination chamber may contain both dissolved and suspended solids. Preferably the salt water should be removed from the desalination chamber and then returned to the first pipeline by any means that will prevent the suspended solids from being returned.

Reference has, so far, been made to the system in the context of desalinating-water. However, it is to be appreciated that the system could be used, within practical limits, to remove any impurity in water or any other fluid including, but not limited to, the removal of salt. Thus, reference to “water” is to be understood as including reference to any fluid; and reference to “salt” is to be understood to include reference to any water (or other fluid) impurities.

In this respect, it would be desirable to provide an arrangement for decontaminating fluid.

Thus, according to another broad aspect of the present invention, there is provided a decontamination pipeline system. The pipeline system includes a first pipeline extending from a decontaminated fluid source for transferring decontaminated fluid therethrough, and at least one decontaminating unit. Each decontaminating unit is in fluid connection with the first pipeline, enabling decontaminated fluid to be drawn from the first pipeline to the at least one decontaminating unit. The decontaminating unit is provided to decontaminate at least part of the decontaminated fluid drawn from the first pipeline. Each decontaminating unit is in fluid connection with a second pipeline extending between the decontaminated fluid source and a target outlet, such that the fluid that has been decontaminated in the decontaminating unit is transferred to the second pipeline.

The present invention is also broadly directed to a decontaminating unit for use in a decontamination pipeline system. The decontaminating unit includes a decontamination chamber. The chamber includes a decontaminated fluid inlet, a dispersal unit for dispersing fluid within the chamber, an evaporated fluid outlet for the removal of the evaporated fluid from within the chamber, a contaminated fluid outlet for removal of non-evaporated contaminated fluid from within the chamber, and a means for providing an air-stream within the chamber.

Further, the invention is broadly directed to a fluid dispersal means for dispersing fluid entering a decontamination chamber. The dispersal means includes one of a shower, spray or other fluid dispersal device, through which fluid passes and is dispersed.

The present invention is further broadly directed to a method of decontaminating fluid. The method includes feeding contaminated fluid into a decontamination chamber through a decontaminated fluid inlet, dispersing the fluid within the chamber, providing an air stream within the chamber, removing evaporated fluid from the chamber through an evaporated fluid outlet, and removing non-evaporated contaminated fluid from within the chamber though a contaminated fluid outlet.

It will be convenient to hereinafter describe preferred embodiments of the invention with reference to the accompanying drawings. The particularity of the drawings is to be understood as not limiting the preceding broad description of the invention.

### IN THE DRAWINGS

FIG. 1 is a diagrammatic layout of a portion of a desalination pipeline system according to a first embodiment of the present invention;

FIG. 2 is a diagrammatic layout of a portion of a desalination pipeline system according to a second embodiment of the present invention;

FIG. 3 is a diagrammatic layout of a portion of a desalination pipeline system according to a third embodiment of the present invention;

FIG. 4 is a diagrammatic plan view of a desalinator according to one embodiment of the present invention;

FIG. 5 is a diagrammatic end view of the desalinator illustrated in FIG. 4.

FIG. 6 is another representation of the portion of desalination pipeline system illustrated in FIG. 1.

FIG. 7 is a diagrammatic layout of a portion of a desalination pipeline system according to a fourth embodiment of the present invention.

FIG. 8 is a magnified view of the desalinator of the pipeline system illustrated in FIG. 7.

FIG. 9 is a diagrammatic layout of a portion of a desalination pipeline system according to a fifth embodiment of the present invention.

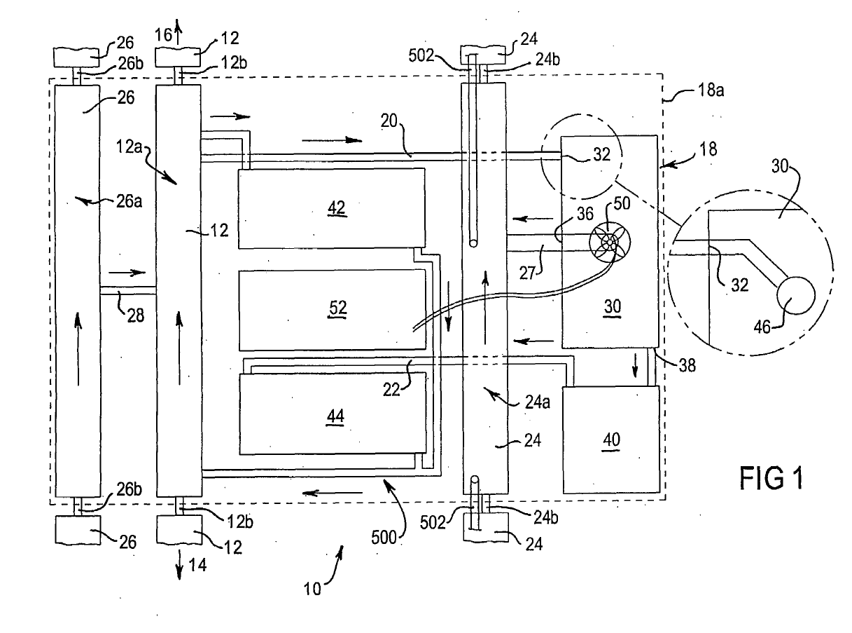

Referring to FIG. 1, there is illustrated a portion of a desalination pipeline system 10. The pipeline system 10 includes a first pipeline 12 extending between a salt water source 14 and a target outlet 16 for transferring salt water therethrough. The system 10 includes a salt water desalinator 18. The salt-water desalinator 18 is in fluid connection with the first pipeline 12 via connection pipes 20, 22. The connection pipe 20 allows salt-water to be drawn from the first pipeline 12 to the desalinator 18. The connection pipe 22 allows salt-water not desalinated in the desalinator 18 to be returned to the first pipeline 12.

The salt-water desalinator 18 is provided for desalinating part of the salt-water drawn from the first pipeline 12. Indeed, it is envisaged that the desalinator 18 would convert a portion of the salt-water into fresh water. The desalinator 18 is in fluid connection with the second pipeline 24 extending between the salt water source 14 and the target outlet 16, via a connection pipe 27, such that the desalinated (evaporated) water produced in the desalinator 18 is transferred to the second pipeline 24. The second pipeline 24 carries only desalinated, fresh water.

The pipeline system 10 includes a third pipeline 26 extending between the salt water source 14 and the target outlet 16, the third pipeline 26 being in fluid connection with the first pipeline 12 via a connection pipe 28. The third pipeline 26 is optional, and is included in this embodiment for replenishing the first pipeline 12 with salt water upon the desalinator 18 desalinating salt water removed from the first pipeline 12.

Reference to the target outlet 16 is to be generally understood to include any one or more of a dam, reservoir, catchment or other fresh water reserve, while the salt water source 14 may be the ocean. It is to be appreciated that the salt water source 14 could also be, for example, a salt-damaged river or waterway. In this respect, the present invention may be used to desirably reduce the salt level in such rivers or waterways.

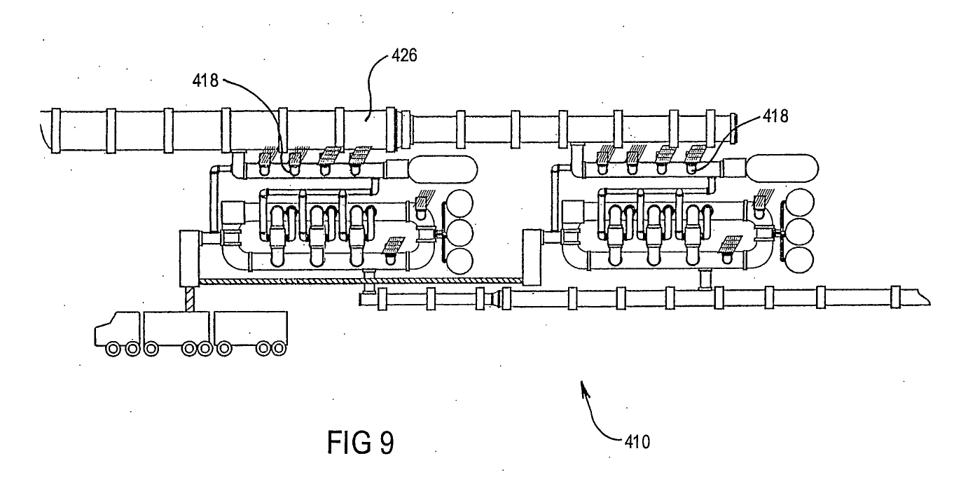

Although not illustrated, the system 10 may include two desalinating modules (FIG. 9 illustrates a system with two desalinating modules). Any number of desalinating modules could be located at desired and/or convenient locations along the pipeline system 10. Each module includes a desalinator 18, a section 12a of the first pipeline 12, a section 24a of the second pipeline 24 and (optionally) a section 26a of the third pipeline 26. If the optional third pipeline is not used then the first pipeline sections may be in fluid connection with each other, or the first pipeline sections must be separately in fluid connection with a source of salt or waste water. For example, a desalinator 18 may be located along the pipeline system 10 so as to desalinate water at each of those locations.

It is envisaged that each of the desalinating modules 18a would be connected in series between the salt water source 14 and a target outlet 16. However, being modular, the system 10 could incorporate two or more modules 18a provided in parallel. Each module 18a may include more than one desalinator 18, if desired. The modules 18a and pipeline system sections may be arranged in any desired sequence. While, generally speaking, each of the modules 18a would be located above ground, the pipeline system sections may be located either above or below ground.

Each module includes connectors 12b, 24b, 26b for connecting the respective pipeline sections 12a, 24a, 26a to the pipeline sections of adjacent modules or pipeline sections.

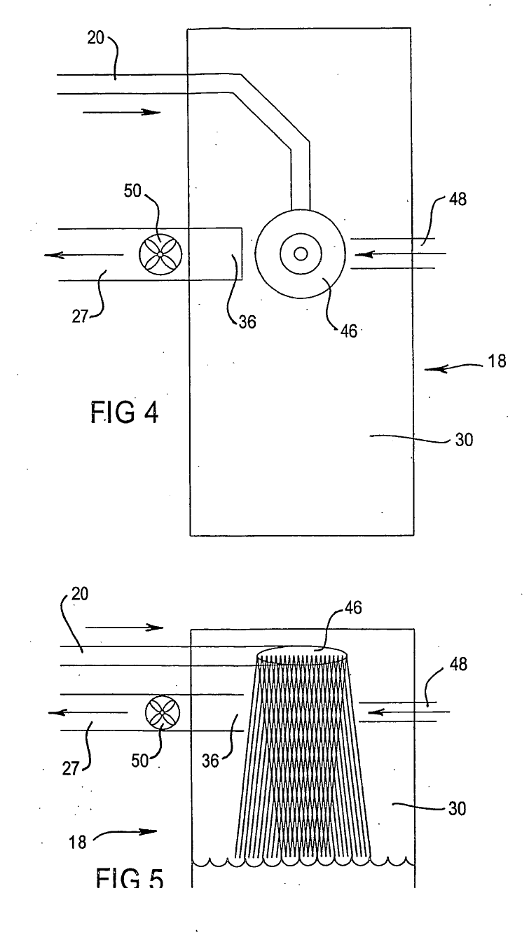

The desalinator 18 used in the desalination pipeline system 10 is illustrated in greater detail in FIGS. 4, 5 and 6. The desalinator 18 includes a desalinating chamber 30 (see also magnified inset provided in FIG. 1). The chamber 30 includes a salt-water inlet 32 for receiving salt-water from the first pipeline 12 via a connection pipe 20 and a water dispersal unit in the form of a spray or shower-type head 46. In operation, the chamber 30 includes hot salty water with increased saltiness compared to the saltiness of the salt water entering the chamber 30. Salt tends to collect at the bottom of the chamber 30 and may be periodically removed. The chamber 30 also includes an evaporated water outlet 36 for the removal of the evaporated water from within the chamber 30 to the second pipeline 24 via connection pipe 26, and a salt-water outlet or overflow 38 for removal of non-evaporated salt-water from within the chamber 30. The overflow 38 may instead be located at any suitable location on the chamber wall.

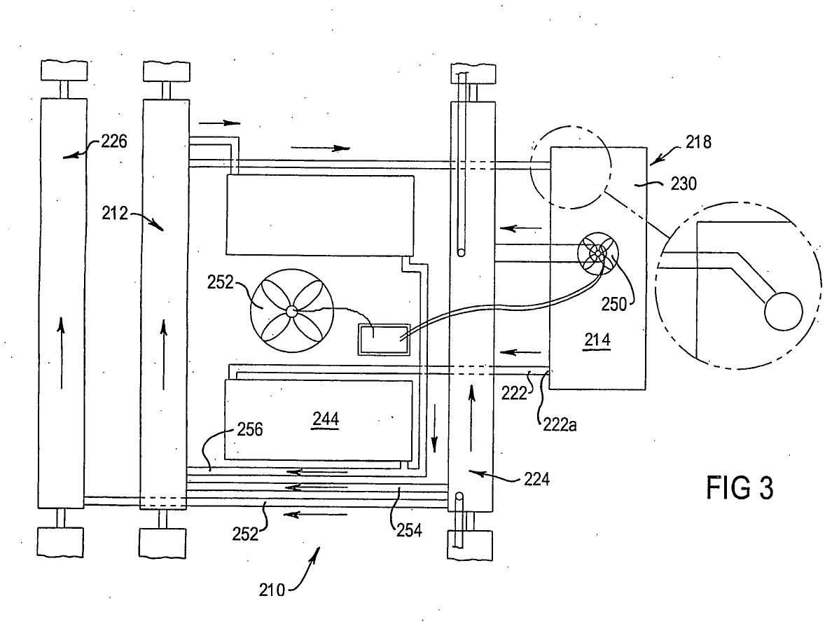

The desalinator 18 includes a salt catchment 40, through which any non-evaporated salt-water from the chamber may flow before returning to the first pipeline. The catchment 40 may also be provided for collecting salt produced in the chamber 30. However, in an alternative embodiment (as illustrated in FIG. 3) the salt produced in the chamber 18 could be fed back into the first pipeline 12 for collection and possible processing at the target outlet 16 or other suitable location in the pipeline system 10. The salt catchment 40 may be provided in the chamber 30 (as per item 218 in FIG. 3) or, as illustrated, may form a separate chamber.

A solar water heater 42 is in fluid connection between the first pipeline 12 and the chamber 30 so as to heat the salt water to any suitable temperature, that may be at or above approximately 55° C. prior to entering the chamber 30. Heating the salt water increases the level of evaporation within the chamber 30. In this way, the efficiency of the desalination process within the chamber 30 is increased.

A second solar heater 44 acting as a thermosiphon removes any non-evaporated salt water from within the catchment 40. The non-evaporated salt water is extracted through pipe 22 and returned to the first pipeline 12 via pipe 500.

It is not necessary that solar heaters are used. In some industrial applications it may be that other heat or energy sources are better choices. Any type of heaters may be used but, in the case of other heaters, pumps may be required in addition to the heaters if the heaters do not also act as thermosiphons.

The shower or spray device 46 is provided within the chamber 30 for spraying, showering or otherwise dispersing the salt-water entering the chamber in a downwards direction from the top of the chamber 30. The salt-water is dispersed to assist in the evaporation of fresh water from the salt water. It is to be appreciated that the water need not be sprayed downwards. It could be sprayed, for example, in an upwards direction. Further if the water entering the chamber is to be suspended, for example in evaporation pads, then it does not actually have to be sprayed. It could simply be poured into the chamber.

An air intake 48 (see FIGS. 4 and 5) is provided for feeding air into the chamber across or through the shower or spray of hot salt-water to further assist in the desalination (evaporation) process.

The chamber 30 includes an extraction fan 50 for extracting the evaporated water through the evaporated water outlet 36. The extraction fan 50 may be powered by any suitable means and, in the illustrated embodiment, is powered by a solar panel 52. The extraction fan 50 may instead be located within the connection pipe 27.

The desalination pipeline system 10 includes a means for pumping the salt-water through each of the first pipeline 12 and third pipeline 26 towards the target outlet in the form of one or more pumps (not illustrated). Likewise, the system 10 includes means for pumping desalinated water in the second pipeline 24 towards the target outlet in the form of one or more pumps (not illustrated). These pumps may be solar powered, windmills, or any other suitable pump.

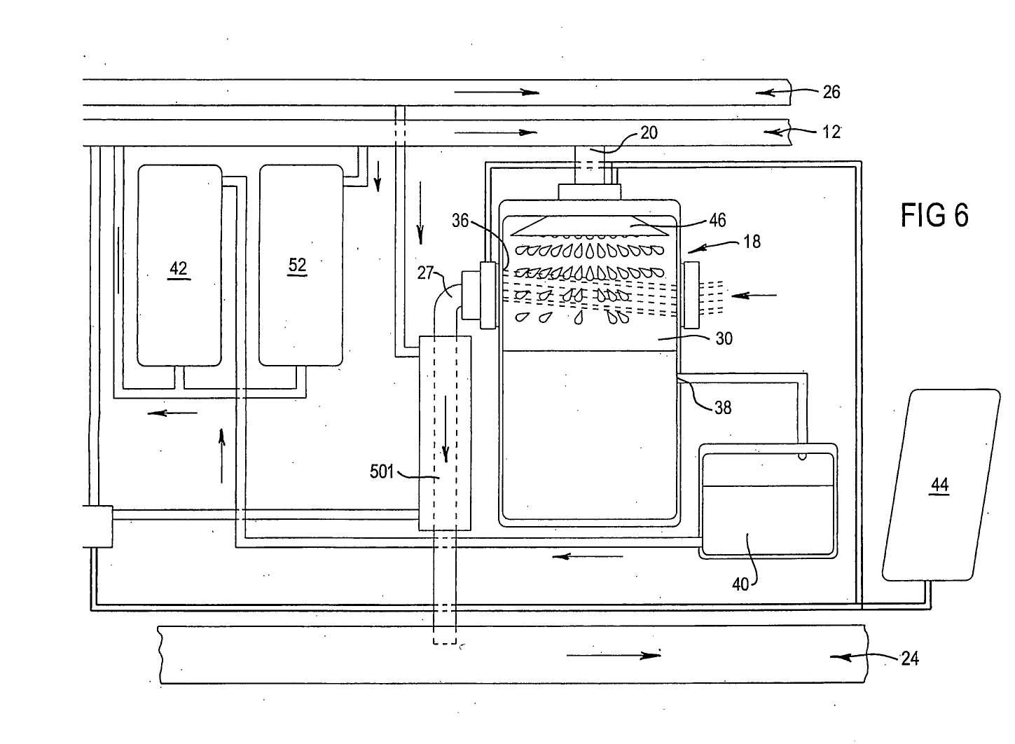

Although not illustrated, each of the first pipeline 12, second pipeline 24 and third pipeline 26 are insulated along at least a portion of their respective lengths adjacent or near the desalinator 18 to reduce heat energy losses to the lower outside ambient temperatures. Any suitable insulation type may be adopted. The second pipeline 26 may form part of a shell and tube heat exchanger 501 (as illustrated in FIG. 6), with fresh water vapour flowing through and being condensed in an inner tube and salt water flowing through the shell surrounding the inner tube. In such an arrangement, the salt-water absorbs the energy lost from the water vapour when it condenses. This increases the temperature of the salt-water entering the chamber 30, which improves the overall efficiency of the desalination process.

In operation, heated salt-water is fed from the first pipeline 12 into the desalination chamber 30 through the salt-water inlet 32. The shower or spray device 46 sprays, showers or otherwise disperses the heated salt-water downwardly through the chamber 30, and at the same time, the air intake 48 feeds air into the chamber 30 across or through the shower or spray of heated water. The extraction fan 50 assists in extracting the evaporated fresh water through the evaporated water outlet 36, while non-evaporated salt-water is removed from the chamber through the salt water overflow outlet 38 to the first pipeline 12 either directly, or via salt catchment 40.

The extraction fan 50 may be replaced by any other suitable device. For example, a pressure control (not illustrated) may be provided, to control pressure in the extraction pipe, such that air pressure in the extraction pipe is maintained at a lower revel than the pressure in chamber 30. Such an arrangement can also be used to draw air into the chamber from outside the chamber, and to control air flow.

The spray device 46 may include a heating unit to further heat the salt-water on entering the chamber, to further increase the operating efficiency of the desalinator. The heating unit may be solar powered or powered by any other suitable means.

The salt and other heavy impurities will tend to be left in the bottom of chamber 30 below the overflow outlet 38, and may be periodically removed.

It is to be appreciated that the salt-water entering the chamber 30 need not be heated. In some climates the desalination process will work without additional heating. In these climates the pipeline need not be insulated.

The salt may be removed from a multiple desalinator system at any suitable location.

Air pressure migration tubes 502 are provided for migrating air pressure between neighbouring modules 18A along the system 10. Alternatively, pressure control devices, equipped with filters to prevent evaporated water escaping, may be used to release to the atmosphere any excess pressure in the second pipeline.

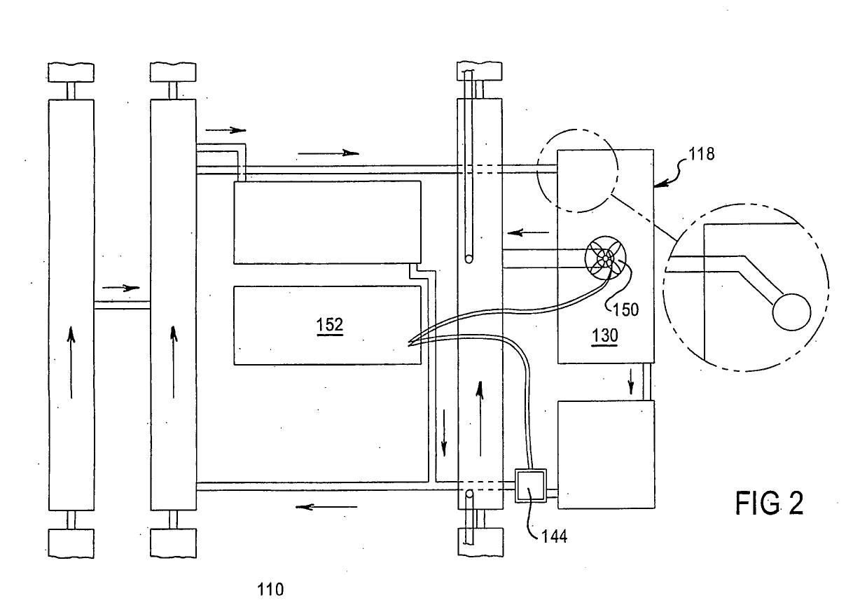

The desalination pipeline system 110 illustrated in FIG. 2 is similar in many respects to the system 10 illustrated in FIG. 1. One notable difference between the systems 10 and 110 is that the salt-water returning from the chamber 130 to the first pipeline 112 is pumped not by a solar powered thermosiphon, but instead by a solar powered pump 144. The pump 144 is powered by the same solar panel 152 used to power the extraction fan 150 of the desalination chamber 130.

Likewise, the desalination pipeline system 210 illustrated in FIG. 3 is similar in many respects to system 10 illustrated in FIG. 1. One notable difference is that the extraction fan 250 of the desalination chamber 230 is powered by a wind power unit 252, rather than a solar panel. A further difference is that the desalination chamber and salt catchment have been combined into the one chamber 214. This results in salt and other heavy impurities continuing through the first pipeline 212 towards the target outlet rather than being left in the bottom of the chamber 230 below the outlet 222a.

This arrangement also does not include a connection pipe between the first pipeline 212 and third pipeline 226. Instead, salt-water to replenish the first pipeline 212 is first passed through the outer shell of the second pipeline 224 via connection pipe 252; the second pipeline 224 being configured as a shell and tube (or any other suitable) heat exchanger. This salt-water is then returned from the outer shell of the second pipeline 224 via connection pipe 254 to the first pipeline 212. Salt-water heated in the solar water heater 244 after exiting the chamber 230 is returned to the first pipeline 212 to either continue to the next desalinator, or return to the chamber 230.

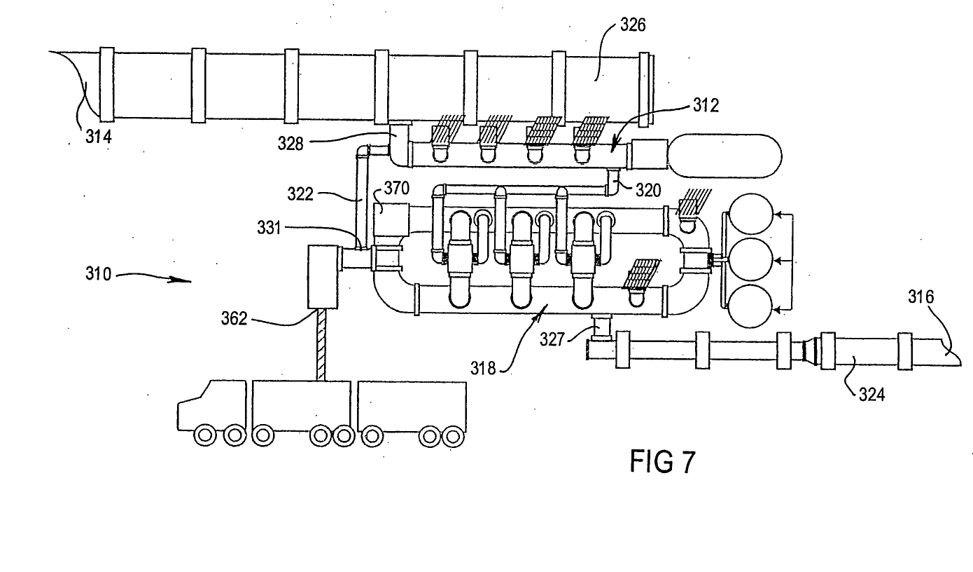

Referring to FIG. 7 there is a single unit portion of a desalination pipeline system 310. In this diagram the desalination pipeline system 310 is configured as a water recycling system. There is a first pipeline 312 in fluid connection with a third pipeline 326 (which is a source of waste water) and a second pipeline 324 (which contains fresh water) extending between a waste water source 314 and a target outlet 316 for transferring waste water therethrough.

The system includes a salt water desalinator 318 (in this case a waste water cleaner). The desalinator 318 is in fluid connection with the first pipeline 312 via connection pipes 320 and 322. The connection pipe 320 allows waste water to be drawn from the first pipeline 312 into the desalinator 318. The connection pipe 322 allows waste water not cleaned in the desalinator 318 to be returned to the first pipeline 312.

The desalinator 318 is provided for cleaning part of the waste water drawn from the first pipeline 312. Indeed, it is envisaged that the desalinator 318 would convert a portion of the waste-water into fresh water. The desalinator 318 is in fluid connection with the second pipeline 324 extending between the waste water source 314 and the target outlet 316 via a connection pipe 327, such that the desalinated water produced in the desalinator 318 is transferred to the second pipeline 324. The second pipeline 324 carries only desalinated, fresh water.

The pipeline system 310 includes a third pipeline 326 extending between the waste water source 314 and the target outlet 316, the third pipeline 326 being in fluid connection with the first pipeline 312 via a connection pipe 328.

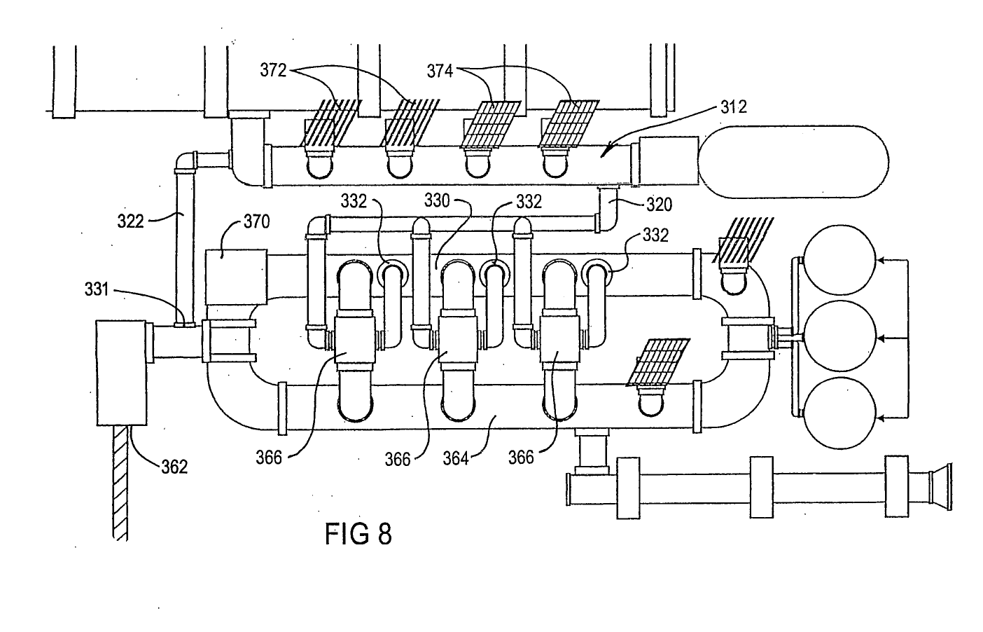

A magnified view of the desalinator 318 is illustrated in FIG. 8. The desalinator 318 in this embodiment includes a desalination chamber 330. The chamber 330 includes multiple salt water inlets 332 for receiving waste water from the first pipeline 312 via fluid connection pipe 320. In this embodiment the waste water is sprayed down from the salt water inlets 332 onto evaporation pads (not illustrated). In operation, the chamber 330 includes hot waste water with increased concentration of waste compared to the concentration in the waste water entering the chamber 330. Waste will collect at the bottom of the chamber 330 in water that has flushed through the evaporation pads and has not been evaporated. Non-evaporated waste water is removed via a fluid connection 331. Waste water (without suspended solids) is returned to the first pipe line 312 for processing via a connecting pipe 322 using any appropriate means (for example, a filter) for preventing suspended solids from being returned. Wet waste is extracted for removal from outlet 362. The chamber 330 also includes a condensation chamber 364. The condensation chamber 364 in this embodiment is in air-low connection to the evaporation chamber 330. In this embodiment the condensation chamber 364 is cooled by solar chillers 366. Heat is pumped from the condensation chamber 364 to the evaporation chamber 330.

Reduction of temperature in the condensation chamber 364 increases the amount of fresh water output. Heat lost during the condensation process can advantageously be used to heat air in the evaporation chamber 330. Addition of heating in between multiple evaporation pads (note adjacency of the salt water inlets 332 and the desalination chamber 330) can advantageously be used to increase total evaporation.

Any appropriate heat pumping device can be used, but the use of solar powered heat pumps and/or high efficiency heat pumps can be advantageous. The recovery of energy from the condensation process and the input of that energy into the evaporation process are advantageous in reducing the net energy cost of the evaporation process.

In this embodiment, solar chillers use some heat from the waste water before it enters the evaporation chamber 330. The efficiency of the solar chillers 368, the recovery of heat from the condensation chamber 364 and the input of that heat in the evaporation chamber 330 make this advantageous.

Air is circulated through the desalination chamber 330 using a flow control fan 370.

Waste water is advantageously pre-heated before entering the evaporation chamber 330 in this embodiment using a combination of flat plate 372 and solar tube 374 heaters in the first pipeline 312, and an additional optional gas heating unit 376 is also shown, before it is extracted via the connecting pipe 320. Air is advantageously pre-heated before it enters the evaporation chamber 330 in this embodiment using a combination of flat plate 372 and solar tube heaters 374.

Many methods for preheating the air and/or water can increase the efficiency of the desalination process. Because relatively low temperatures are still advantageous the present invention can take advantage of many low-grade heat sources.

In this embodiment an optional gas mix is illustrated demonstrating the possibility that some gases may advantageously be added to the desalination chamber 330 to either increase the efficiency of the process, or to have some other desirable effect.

FIG. 9, illustrates a multiple unit installation 410, the third pipeline 426 can be seen to be in fluid connection with multiple desalination units 418.

The present invention provides numerous potential benefits.

System can be built in a modular fashion, such that is can be relatively easily designed to suit a specific application.

Being modular, it is relatively simple to bypass a desalinator in the event of desalinator failure, repair, maintenance or terrorist sabotage. Further, even if one desalinator becomes inoperable, the remaining desalinators in the system should still be operational once any broken sections of the three pipelines are repaired or replaced.

Advantageously, the system enables a desalinator to be placed at practically any location along the pipeline system.

Fresh water produced by a desalinator at any location along the system continues in the fresh water pipe towards the outlet, or any fresh water extraction point.

Advantageously, the present system requires a much smaller desalination plant at the final pipeline system destination because much desalination occurs in the desalinators along the pipeline system. Indeed, the present system makes the need for a desalinator at the target outlet optional.

Unlike existing desalination and pipeline systems, the desalination process of the present invention can be largely if not totally powered by environmentally friendly power sources, such as solar power and wind power.

System can be equally adapted for use over many hundreds or even thousands of kilometres or even less than a single kilometre.

The inventive system can be used for domestic and/or commercial and/or industrial use, as well as for agricultural use.

The inventive system can be used to clean a wide variety any other non-evaporative compounds/contaminants from various water and other fluids. Thus reference within this specification to ‘desalination’ is understood to include reference to ‘desalination and/or decontamination’. The system can be used effectively and very usefully to remove sediment from fluid so long as that sediment will not evaporate and the fluid will evaporate at the operational temperatures being used. As one example, the system may be used to remove dirt from bore water. Alternatively, the system may be used to clean dirty and/or polluted and/or insect-infested water from a pond.

A yet further example of a potential use for the inventive system includes removing from water the impurities produced in paper manufacturing processes, to create fresh water and a remaining sludge that can more easily and environmentally be disposed of as compared to disposing of the untreated water.

Further, the system can make use of readily available seawater.

Advantageously, the system includes separate pipelines for salt-water and desalinated water. Therefore it is difficult if not impossible for the salt-water to contaminate the desalinated water.

The system can advantageously be used to reduce undesirably high salt levels in rivers and waterways by diverting some salt-water through the desalination pipeline system and then feeding fresh water back into the river or waterway.

It is not necessary for salt-water to be treated at the target destination, although it may be useful. The salt-water pipelines (the first and third pipelines) may be capped at the target outlet.

Further, It is to be appreciated that the creation of highly saline water can be advantageous. It is therefore to be understood that the present invention can be used to convert saline water into separate outputs of highly saline water, and fresh water (or lowly saline water), both of which may be separately useful.

Likewise, should the system be used to process a contaminated fluid, it may be advantageously used to convert a contaminated fluid into separate outputs of highly contaminated fluid and uncontaminated fluid; or highly contaminated and lowly contaminated fluids both of which may be separately useful.

Finally, it is to be understood that various alterations, modifications and/or additions may be introduced into the construction and arrangement of the parts previously described without departing from the spirit or ambit of this invention.

Without limiting the claim scope that may be sought in any Australian or overseas patent application claiming priority from the present application, the following claims are provided.

1. A pipeline system, including:
a first pipeline extending from a salt water source for transferring salt water therethrough,
at least one salt water desalinator in fluid connection with the first pipeline, enabling salt water to be drawn from the first pipeline to the at least one desalinator,
each salt water desalinator provided to desalinate at least a part of the water drawn from the first pipeline,
each desalinator being in fluid connection with a second pipeline extending between each respective desalinator and the target outlet, such that the water that has been desalinated in the desalinator is transferred to the second pipeline,
wherein at least one desalinator includes a desalinating chamber, each chamber including an air intake configured for, in use, feeding an airstream into the chamber to generate a generally non-vortex airflow within the chamber.

2. A pipeline system according to claim 1, including a third pipeline extending from the salt water source, the third pipeline being in fluid connection with the first pipeline, the third pipeline provided for replenishing the first pipeline with salt water upon each desalinator desalinating salt water removed from the first pipeline into desalinated water.

3. A pipeline system according to claim 1, wherein the desalinated water is substantially fresh water.

4. A pipeline system according to claim 1, wherein the system is modular, including at least one desalinator module, the module including first and second pipeline sections.

5. A pipeline section according to claim 4, wherein the module includes a third pipeline section.

6. A pipeline system according to claim 1, including two or more desalinators located along the pipeline system.

7. A pipeline system according to claim 6, wherein at least two desalinators are connected in series between the salt water source and a target outlet.

8. A pipeline system according to claim 6, wherein at least two desalinators are connected in parallel between the salt water source and a target outlet.

9. A pipeline system according to claim 1, wherein the salt-water fed from the first pipeline is heated prior to reaching each desalinator.

10. A pipeline system according to claim 9, wherein the salt-water fed from the first pipeline to each desalinator is heated by one or more solar heaters.

11. A pipeline system according to claim 2, wherein one or more of the first, second and third pipelines, or a section of at least one desalinator are insulated.

12. A pipeline system according to claim 11, wherein each of the first, second and third pipelines and desalinator sections are insulated.

13. A pipeline system according to claim 1, wherein the second pipeline forms part of, or is in fluid connection with, a heat exchange or heat pumping device(s) for energy recovery from one part of the desalination process for reuse in other parts of the desalination process.

14. A pipeline system according to claim 2, comprising means for pumping the salt-water in the first and third pipelines towards the target outlet.

15. A pipeline system according to claim 1, including means for pumping desalinated salt-water in the second pipeline towards the target outlet.

16. A desalinator for a desalination pipeline system, the desalinator including a desalinating chamber, the chamber including:
a salt-water inlet,
a water dispersal unit for dispersing water within the chamber,
an evaporated water outlet for the removal of evaporated water from within the chamber,
a salt-water outlet for removal of non-evaporated salt-water from within the chamber,
and a means for providing a generally non-vortex air stream within the chamber.

17. A desalinator according to claim 16, wherein the salt-water outlet is in fluid communication with a salt-water supply pipeline.

18. A desalinator according to claim 16, wherein the desalinating chamber includes a salt catchment for collecting salt produced in the chamber.

19. A desalinator according to claim 18, wherein the salt catchment is located external of the chamber.

20. A desalinator according to claim 16, including one or more of a solar powered thermosiphon or pump for removing salt-water from the chamber.

21. A desalinator according to claim 16, including an extraction fan for extracting evaporated water through the evaporated water outlet.

22. A desalinator according to claim 21, wherein the extraction fan is powered by one or more of a solar power unit and/or a wind power unit.

23. A desalinator according to claim 16, including a means for reducing the pressure within the chamber.

24. A desalinator according to claim 16, wherein the saltwater outlet is provided as a chamber overflow, the chamber overflow being in fluid connection to the first pipeline via an overflow chamber.

25. A water dispersal means for dispersing water entering a desalinating chamber, the dispersal means including one or more of a shower, spray or other water dispersal device, through which water passes and is dispersed.

26. A method of desalinating salt-water, including:
feeding salt-water into a desalination chamber through a salt-water inlet,
dispersing the water within the chamber,
providing a generally non-vortex air stream within the chamber,
removing the evaporated water from the chamber through an evaporated water outlet, and
removing non-evaporated salt-water from within the chamber through a salt-water outlet.

27. A method of desalinating salt-water according to claim 26, including removal of salt from within the chamber through a salt outlet.

28. A method of desalinating salt-water according to claim 26, including removal of salt from within the chamber with the non-evaporated salt-water through the salt-water outlet.

29. A method of desalinating salt-water according to claim 26, including heating the salt-water prior to entering the desalination chamber.

30. A method of desalinating salt-water according to including operating an extraction fan, turbine or other air-flow device to enhance removal of evaporated water from within the chamber.

31. A method of desalinating salt-water according to claim 26, including removing evaporated, water from the chamber through the evaporated water outlet using a pressure differential between the outlet and the chamber.

32. A decontamination pipeline system, including:
a first pipeline extending from a decontaminated fluid source for transferring decontaminated fluid therethrough, and
at least one decontaminating unit, each decontaminating unit being in fluid connection with the first pipeline, enabling decontaminated fluid to be drawn from the first pipeline to the at least one decontaminating unit,
the decontaminating unit being provided to decontaminate at least part of the decontaminated fluid drawn from the first pipeline, and
each decontaminating unit being in fluid connection with a second pipeline extending between each respective decontaminating unit and a target outlet, such that the fluid that has been decontaminated in the decontaminating unit is transferred to the second pipelines
wherein at least one decontaminating unit includes a decontamination chamber, each chamber including an air intake configured for, in use, feeding an airstream into the chamber to generate a generally non-vortex airflow within the chamber.

33. A decontaminating unit for use in a decontamination pipeline system, including a decontamination chamber, the chamber including:
a decontaminated fluid inlet,
a dispersal unit for dispersing fluid within the chamber,
an evaporated fluid outlet for the removal of the evaporated fluid from within the chamber,
a contaminated fluid outlet for removal of non-evaporated contaminated fluid from within the chamber, and
a means for providing a generally non-vortex air-stream within the chamber.

34. A fluid dispersal means for dispersing fluid entering a decontamination chamber, the dispersal means including one of a shower, spray or other fluid dispersal device, through which fluid passes and is dispersed.

35.-40. (canceled)
